(19) United States
(12) Patent Application Publication
(10) Pub. No.: US 2006/0025152 A1
(43) Pub. Date: Feb. 2, 2006

(54) Apparatus and method of controlling diversity reception for mobile communication terminal combined with satellite DMB receiver

(75) Inventor: Young Kyun Ban, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Pantech Co., LTD

(21) Appl. No.: 11/139,831

(22) Filed: May 27, 2005

(30) Foreign Application Priority Data
Jul. 28, 2004 (KR) 10-2004-0059242

(51) Int. Cl. H04Q 7/20

(52) U.S. Cl. 455/456.1; 455/456.6

(57) ABSTRACT

Disclosed are an apparatus and a method of controlling diversity reception for a mobile communication terminal combined with a satellite digital multimedia broadcasting (DMB) receiver, which may control operations of an antenna and a tuner of the satellite DMB receiver using position information obtained by global positioning system (GPS). There is provided an apparatus for controlling diversity reception for a mobile communication terminal combined with a satellite DMB receiver comprising: a GPS antenna for receiving information on position of the mobile communication terminal using GPS; and a main control unit for performing general controls for the apparatus, checking position of the mobile communication terminal by using the position information received through the GPS antenna, and controlling on/off of the tuner unit according to position of the mobile communication terminal to receive DMB signals only through a set of antenna and RF tuner that can best receive the DMB signals.

### CROSS-REFERENCE TO RELATED APPLICATION

The present application is claiming priority of Korean Patent Application No. 10-2004-0059242, filed on Jul. 28, 2004, the content of which is incorporated herein by reference.

### BACKGROUND OF THE INVENTION

1. Field of the Invention

The present invention relates to a mobile communication terminal combined with a satellite digital multimedia broadcasting (DMB) receiver. More particularly, the present invention relates to an apparatus and a method of controlling diversity reception for a mobile communication terminal combined with a satellite DMB receiver, which may control operations of an antenna and a tuner of the satellite DMB receiver using information on position of the mobile communication terminal obtained by global positioning system (GPS).

2. Background of the Related Art

As mobile communication technologies are recently developed, mobile communication terminals such as a personal communication service (PCS) phone, a cellular phone, a personal digital assistance (PDA), a notebook and a vehicle communication device are widely used. Such mobile communication terminals have been gradually miniaturized and functions thereof have been diversified. Recently, even a satellite DMB receiver capable of receiving satellite digital multimedia broadcasting service has been mounted to the mobile communication terminal.

A series of operations of letting users viewing the satellite DMB programs with the mobile communication terminal combined with a satellite DMB receiver will be described hereinafter with reference to FIG. 1. First, a satellite DMB center 12 modulates DMB programs (video, audio and data, etc.) received from a contents provider 11 and transmits signals containing the DMB programs (“DMB signals”) to a satellite 13 via Ku band (11 GHz or 12 GHz). Then, the satellite 13 transmits the DMB signals to a mobile communication terminal 15 combined with a satellite DMB receiver. At this time, the satellite 13 directly transmits the DMB signals to the mobile communication terminal 15 combined with the satellite DMB receiver via S band (2.6 GHz) or transmits the DMB signals to a gap filler 14 via the Ku band. The DMB signals transmitted to the gap filler is again transmitted to the mobile communication terminal 15 via S band (2.6 GHz). Accordingly, the mobile communication terminal 15 combined with the satellite DMB receiver demodulates the DMB signals received via the two paths and, then, provides the satellite DMB programs to a user of the mobile communication terminal combined with the satellite DMB receiver. At this time, when the mobile communication terminal is in an area such as the suburbs where the DMB signals can best be received directly from the satellite, the DMB signals are directly transmitted to the mobile communication terminal from the satellite. In contrast, when the mobile communication terminal is in an area where the DMB signals is not favorably received from the satellite, the DMB signals are transmitted via the gap filler.

The mobile communication terminal combined with the satellite DMB receiver of the prior art has a structure for diversity reception including two sets of antenna and radio frequency (RF) tuner. In other words, it has two different sets of antenna and RF tuner for respectively receiving the DMB signals received directly from the satellite 13 (i.e., Right Hand Circular Polarization (RHCP)) and DMB signals received via the gap filler 14 (i.e., Linear Polarization (LP)).

In connection with this, currently commercialized mobile communication terminals combined with the satellite DMB receiver are classified into two types. For example, when an antenna for receiving DMB signals directly from a satellite (“satellite antenna”) is detachable and an antenna for DMB signals via a gap filler (“gap filler antenna”) is fixed, the satellite DMB programs are provided to the user by the fixed gap filler antenna's receiving at ordinary times. On the other hand, when the DMB signals received via the gap filler are too weak, the satellite antenna is attached to the mobile communication terminal to receive the DMB signals directly from the satellite.

For another example, when both the satellite antenna and the gap filler antenna are fixed to the mobile communication terminal, each set of the antenna and the tuner is respectively operated to receive the DMB signals.

However, according to the prior art, when the detachable satellite antenna is provided to the mobile communication terminal, a user need to judge strength of the received DMB signals on the basis of her or his own standard and then detach/attach the satellite antenna. Further, when fixed antennas are provided to the mobile communication terminal, battery power is wasted because two tuners are always used.

### SUMMARY OF THE INVENTION

Accordingly, the present invention has been made to solve the above-mentioned problems occurring in the prior art. The object of the present invention is to automatically inform user of a mobile communication terminal combined with a satellite DMB receiver of necessity of attachment/detachment of a satellite antenna and to control on/off of the tuners in the satellite DMB receiver, according to the mobile communication terminal's position, by continuously checking the mobile communication terminal's position using GPS when receiving satellite DMB signals.

Another object of the present invention is to receive DMB signals only through a set of an antenna and a RF tuner that can best receive the DMB signals, by controlling on/off of RF tuner for a satellite (“a satellite tuner”) and RF tuner for a gap filler (“a gap filler tuner”) according to position of a mobile communication terminal combined with a satellite DMB receiver.

The other object of the present invention is to reduce consumption of battery power in a mobile communication terminal combined with a satellite DMB receiver compared to that of a mobile communication terminal of the prior art which provides all two RF tuners with power, by controlling on/off of the sets of the antenna and RF tuner according to position of the mobile communication terminal to receive DMB signals only through a set of an antenna and RF tuner that can best receive the DMB signals.

In order to achieve at least the above objects, there is provided an apparatus for controlling diversity reception for a mobile communication terminal combined with a satellite digital multimedia broadcasting (DMB) receiver including a satellite antenna, a gap filler antenna and a tuner unit consisting of radio frequency (RF) tuners, connected to each of the antennas, for performing tuning functions, comprising: a global positioning system (GPS) antenna for receiving information on position of the mobile communication terminal using GPS; and a main control unit for performing general controls for the apparatus, checking position of the mobile communication terminal by using the position information received through the GPS antenna, and controlling on/off of the tuner unit according to position of the mobile communication terminal to receive DMB signals only through a set of antenna and RF tuner that can best receive the DMB signals.

Preferably, the main control unit may control the tuner unit to drive only the gap filler tuner, if the mobile communication terminal is in an area where the DMB signals can best be received via a gap filler.

Preferably, the main control unit may control the tuner unit to drive only the satellite tuner, if the mobile communication terminal is in an area where the DMB signals can best be received directly from a satellite.

Differently, in order to achieve the above objects, there is a method of controlling diversity reception for a mobile communication terminal combined with a satellite DMB receiver comprising: checking position of the mobile communication terminal by receiving and analyzing information on position of the mobile communication terminal using GPS; checking environment of the mobile communication terminal to receive DMB signals, with reference to the position of the mobile communication terminal; and controlling on/off of a satellite tuner and a gap filler tuner of the satellite DMB receiver, so that the DMB signals are received only through the set of the antenna and the RF tuner that can best receive the DMB signals.

Preferably, said checking the environment of the mobile communication terminal to receive the DMB signals may check whether the mobile communication terminal is in an area where the DMB signals can best be received directly from the satellite (“satellite predominance area”) or an area where the DMB signals can best be received via the gap filler (“gap filler predominance area”), by checking information on the predominance areas stored in a base station with reference to the position of the mobile communication terminal.

Preferably, said controlling on/off of the satellite tuner and the gap filler tuner may cut off power for the satellite tuner and drive only the gap filler tuner so as to receive the DMB signals via a gap filler through the antenna and the gap filler tuner if the mobile communication terminal is in an area where the DMB signals can best be received via the gap filler.

Preferably, said controlling on/off of the satellite tuner and the gap filler tuner may cut off power for the gap filler tuner and drive only the satellite tuner so as to receive the DMB signals directly from a satellite through the antenna and the satellite tuner if the mobile communication terminal is in an area where the DMB signals can best be received directly from the satellite.

Preferably, the method may further comprise outputting a message or alarm informing the user of necessity of attaching the satellite antenna to the mobile communication terminal, if the satellite antenna is detachable and the mobile communication terminal is in an area where the DMB signals can best be received directly from the satellite.

### BRIEF DESCRIPTION OF THE DRAWINGS

The above and other objects, features and advantages of the present invention will be more apparent from the following detailed description taken in conjunction with the accompanying drawings, in which:

FIG. 1 is a service conceptual view for illustrating a series of operations of letting users viewing the satellite DMB programs with a mobile communication terminal combined with a satellite DMB receiver;

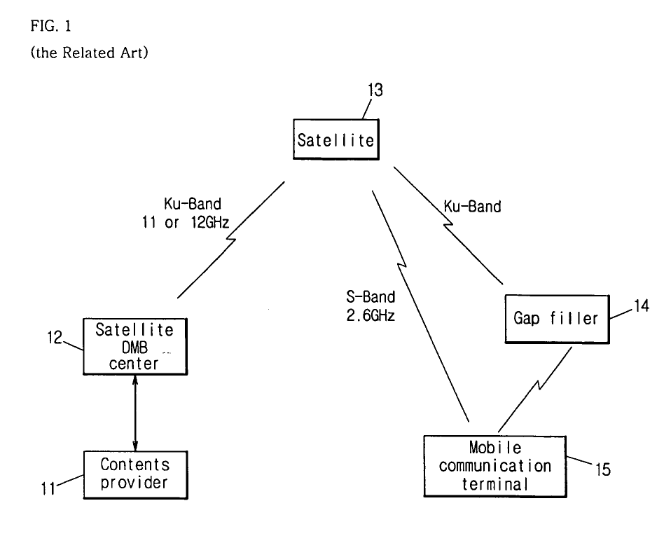

FIG. 2 is a block diagram schematically showing a structure for controlling diversity reception for a mobile communication terminal combined with a satellite DMB receiver according to an embodiment of the present invention; and

FIG. 3 is a flow chart showing operations of controlling diversity reception for a mobile communication terminal combined with a satellite DMB receiver according to an embodiment of the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

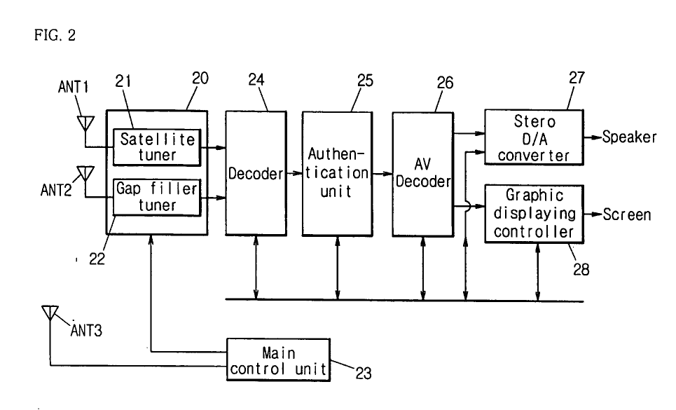

According to the present invention, a position checking function of GPS is added to a mobile communication terminal combined with a satellite DMB receiver. Although methods of obtaining information on position of the mobile communication terminal using GPS will not be described in detail, there would be no problem for the skilled in the art to embody the present invention with this specification. According to position of the mobile communication terminal checked by GPS, sets of Antenna and RF tuner in the satellite DMB receiver are controlled to receive DMB signals only through a set of antenna and RF tuner that can best receive the DMB signals. FIG. 2 illustrates configuration of the mobile communication terminal combined with the satellite DMB receiver.

In other words, as shown in FIG. 2, an apparatus for controlling diversity reception for a mobile communication terminal combined with a satellite DMB receiver according to preferred embodiment of the present invention comprises: a satellite antenna (ANT1) for receiving DMB signals directly from a satellite; a gap filler antenna (ANT2) for receiving DMB signals via a gap filler; a tuner unit 20 consisting of two RF tuners, respectively connected to each of the antennas, for performing tuning functions; a GPS antenna (ANT3) for receiving information on position of the mobile communication terminal using GPS; and a main control unit 23 for performing general controls for the apparatus, checking position of the mobile communication terminal by using the position information received through the GPS antenna (ANT3), and controlling on/off of the tuner unit 20 according to position of the mobile communication terminal to receive DMB signals only through a set of antenna and RF tuner that can best receive the DMB signals.

At this time, the gap filler antenna (ANT2) of the antennas provided to the mobile communication terminal is fixed to the mobile communication terminal, and the satellite antenna (ANT1) can be provided in a fixed or detachable form.

The mobile communication terminal further comprises: a decoder 24 for decoding the DMB signals received through the tuner unit 20; an authentication unit 25 for performing an authenticating process; an A/V decoder 26 for performing an A/V decoding process; and a stereo D/A converter 27 and a graphic displaying controller 28 for outputting the A/V decoded DMB signals through a speaker and a screen of the mobile communication terminal.

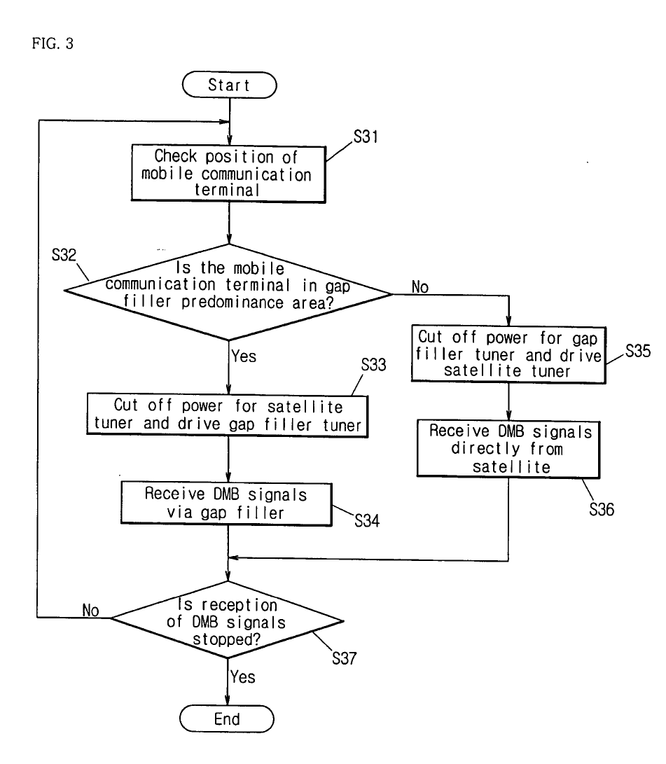

Hereinafter, operations of controlling diversity reception for the mobile communication terminal combined with the satellite DMB receiver having the above described structure will be explained with reference to FIG. 3.

When the main control unit 23 of the mobile communication terminal perceives a user's intention of viewing the satellite DMB programs, it analyzes position information received through the GPS antenna (ANT3) to check position of the mobile communication terminal (S31).

Then, the main control unit 23 checks an environment of the mobile communication terminal to receive the DMB signals with reference to the position information (for example, it checks whether the mobile communication terminal is in an area where the DMB signals can best be received via a gap filler (“a gap filler predominance area”)) (S32). For this, preferably, the main control unit 23 is continuously operated with a base station (not shown), and the base station stores and manages the position information about whether the mobile communication terminal is currently in the gap filler predominance area or an area where the DMB signals can best be received directly from the satellite (“a satellite predominance area”).

If the main control unit 23 check, with reference to position information using GPS, that the mobile communication terminal is in the gap filler predominance area (i.e. shadow area), the main control unit 23 controls the tuner unit 20 to cut off power for the satellite tuner 21 and to drive the gap filler tuner 22 only (S33). Thus, the DMB signals transmitted from the satellite are received via the gap filler which is a ground repeater. At this time, the DMB signals are received through the gap filler antenna (ANT2) and the gap filler tuner 22 (S34). Then, the DMB signals are subject to decoding and authenticating processes, so that a user of the mobile communication terminal can view the satellite DMB programs.

In contrast, if the main control unit 23 check that the mobile communication terminal is in the satellite predominance area (i.e. suburbs, area without a gap filler), the main control unit 23 controls the tuner unit 20 to cut off power for the gap filler tuner 22 and to drive the satellite tuner 21 only (S35). Thus, the DMB signals are directly received from the satellite through the satellite antenna (ANT1) and the satellite tuner 21 (S36). Then, the DMB signals are subject to decoding and authenticating processes, so that the user of the mobile communication terminal can view the satellite DMB programs.

In addition, the main control unit 23 checks whether reception of the DMB signals is stopped or not (S37). If the reception of the DMB signals is not stopped, the main control unit 23 periodically checks position of the mobile communication terminal using GPS. Then, until the reception of the DMB signals is stopped, the main control unit 23 controls the tuner unit 20 to drive a set of antenna and RF tuner that can best receive the DMB signals.

Accordingly, it is possible to view the best quality satellite DMB programs by receiving the DMB signals only through a set of the antenna and the RF tuner appropriate for corresponding position of the mobile communication terminal.

In the mean time, if the satellite antenna (ANT1) is attachable/detachable, the main control unit 23 may be operated differently from the above-described operations when the mobile communication terminal is in the satellite predominance area. In other words, when the satellite antenna (ANT1) is attachable/detachable, the main control unit 23 checks whether the satellite antenna (ANT1) is attached to the mobile communication terminal or not.

If the satellite antenna (ANT1) is not attached to the mobile communication terminal, a message or alarm informing the user of necessity of attaching the satellite antenna (ANT1) to the mobile communication terminal is outputted. This is because it is difficult to receive the DMB signals without the satellite antenna in the satellite predominance area.

In contrast, if the satellite antenna (ANT1) is attached already, the main control unit 23 controls the tuner unit 20 to cut off power for the gap filler tuner 22 and to drive the satellite tuner 21 only, so that the DMB signals are directly received from the satellite through the satellite antenna (ANT1) and the satellite tuner 21.

In addition, when the mobile communication terminal is in the gap filler predominance area, if the detachable satellite antenna (ANT1) is attached to the mobile communication terminal, a message or alarm informing that the user can detach the satellite antenna (ANT1) from the mobile communication terminal is outputted to the user. Accordingly, it is possible to eliminate inconvenience of carrying the mobile communication terminal combined with unnecessary attachment such as the satellite antenna (ANT1) in the gap filler predominance area.

In summary, when the satellite DMB programs are provided to the mobile communication terminal combined with the satellite DMB receiver, the position information is received through the GPS antenna (ANT3) to periodically check position of the mobile communication terminal. According to the position of the mobile communication terminal, on/off control for the tuner unit 20 is performed to receive the DMB signals only through a set of the antenna and the RF tuner appropriate for corresponding position of the mobile communication terminal. Thus, the best quality satellite DMB programs can be provided.

In other words, when the mobile communication terminal is in the suburbs or areas without a gap filler (i.e., the satellite predominance area), the gap filler tuner 22 is turned off and only the satellite tuner 21 is turned on, so that the DMB signals can be received through the set of the satellite antenna (ANT1) and the satellite tuner 21. In contrast, when the mobile communication terminal is in the downtown or areas with many gap fillers (i.e., the gap filler predominance area), the satellite tuner 21 is turned off and only the gap filler tuner 22 is turned on, so that the DMB signals can be received through the set of the gap filler antenna (ANT2) and the gap filler tuner 22. Like this, since the set of the antenna and the RF tuner that can best receive the DMB signals is selected considering the position of the mobile communication terminal, it is possible to provide the best quality satellite DMB programs.

As described above, according to the present invention, when receiving the DMB signals through the satellite DMB receiver in the mobile communication terminal, the position information using GPS is received and analyzed to check the current position of the mobile communication terminal. According to position of the mobile communication terminal, it is possible to inform the user of the mobile communication terminal of the attachment/detachment of the satellite antenna and to control on/off of the satellite tuner and the gap filler tuner. Accordingly, the DMB signals are received only through the set of the antenna and the RF tuner that can best receive the DMB signals, so that it is possible to provide the best quality satellite DMB programs.

Further, according to the present invention, it is possible to control on/off of tuners to selectively use the antennas and the RF tuners according to position of the mobile communication terminal. Accordingly, consumption of the battery power can be reduced compared to that of a mobile communication terminal of the prior art which provides all two RF tuners with power.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. An apparatus for controlling diversity reception for a mobile communication terminal combined with a satellite digital multimedia broadcasting (DMB) receiver including a satellite antenna, a gap filler antenna and a tuner unit consisting of radio frequency (RF) tuners, connected to each of the antennas, for performing tuning functions, comprising:
a global positioning system (GPS) antenna for receiving information on position of the mobile communication terminal using GPS; and
a main control unit for performing general controls for the apparatus, checking position of the mobile communication terminal by using the position information received through the GPS antenna, and controlling on/off of the tuner unit according to position of the mobile communication terminal to receive DMB signals only through a set of antenna and RF tuner that can best receive the DMB signals.

2. The apparatus according to claim 1, wherein the main control unit controls the tuner unit to drive only the gap filler tuner, if the mobile communication terminal is in an area where the DMB signals can best be received via a gap filler.

3. The apparatus according to claim 1, wherein the main control unit controls the tuner unit to drive only the satellite tuner, if the mobile communication terminal is in an area where the DMB signals can best be received directly from a satellite.

4. A method of controlling diversity reception for a mobile communication terminal combined with a satellite DMB receiver comprising:
checking position of the mobile communication terminal by receiving and analyzing information on position of the mobile communication terminal using GPS;
checking environment of the mobile communication terminal to receive DMB signals, with reference to the position of the mobile communication terminal; and
controlling on/off of a satellite tuner and a gap filler tuner of the satellite DMB receiver, so that the DMB signals are received only through the set of the antenna and the RF tuner that can best receive the DMB signals.

5. The method according to claim 4, wherein said checking the environment of the mobile communication terminal to receive the DMB signals is to check whether the mobile communication terminal is in an area where the DMB signals can best be received directly from the satellite (“satellite predominance area”) or an area where the DMB signals can best be received via the gap filler (“gap filler predominance area”), by checking information on the predominance areas stored in a base station with reference to the position of the mobile communication terminal.

6. The method according to claim 4, wherein said controlling on/off of the satellite tuner and the gap filler tuner is to cut off power for the satellite tuner and drive only the gap filler tuner so as to receive the DMB signals via a gap filler through the antenna and the gap filler tuner if the mobile communication terminal is in an area where the DMB signals can best be received via the gap filler.

7. The method according to claim 4, wherein said controlling on/off of the satellite tuner and the gap filler tuner is to cut off power for the gap filler tuner and drive only the satellite tuner so as to receive the DMB signals directly from a satellite through the antenna and the satellite tuner if the mobile communication terminal is in an area where the DMB signals can best be received directly from the satellite.

8. The method according to claim 4, further comprising:
outputting a message or alarm informing the user of necessity of attaching the satellite antenna to the mobile communication terminal, if the satellite antenna is detachable and the mobile communication terminal is in an area where the DMB signals can best be received directly from the satellite.
